(19) United States
(12) Patent Application Publication
(10) Pub. No.: US 2004/0057773 A1
(43) Pub. Date: Mar. 25, 2004

(54) All in one toothbrush

(76) Inventor: Melvin Juuius Gray, Williamsburg, VA (US)

Correspondence Address: Melvin Juuius Gray, 3512 Barretts Ferry Dr., Williamsburg, VA, 23185, US

(21) Appl. No.: 10/368,862

(22) Filed: Jun. 2, 2003

Related U.S. Application Data
(60) Provisional application No. 60/413,196, filed on Sep. 25, 2002.

(51) Int. Cl. A46B 11/04; A47L 13/22; B43K 5/06

(52) U.S. Cl. 401/277; 401/270; 401/175

(57) ABSTRACT

The nature of the all in one toothbrush is to create an aesthetic and ergonomically shaped, reusable toothbrush. The all in one toothbrush integrates a refillable reusable toothpaste cartridge that can be dispensed directly onto the toothbrush bristles and a replaceable brush head unit. The all in one toothbrush and toothpaste-dispensing unit conveniently eliminate the need to have both a toothbrush and toothpaste. The toothbrush also incorporates overmolded grip and pad sections.

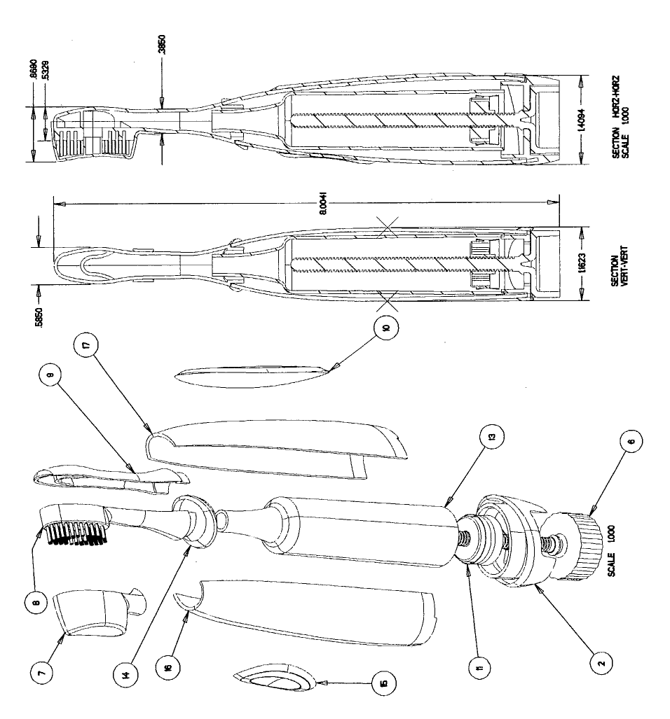

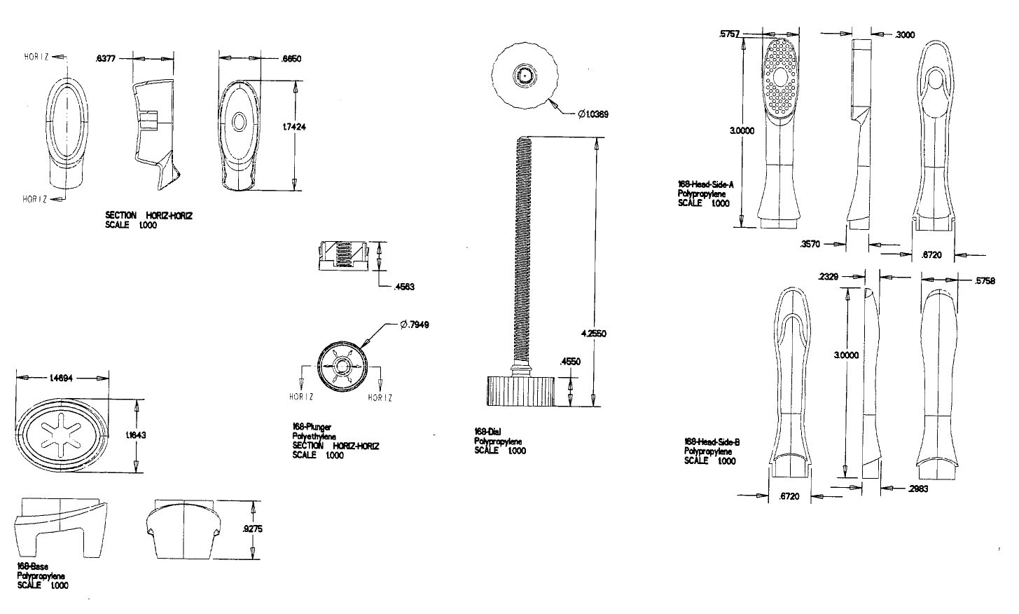

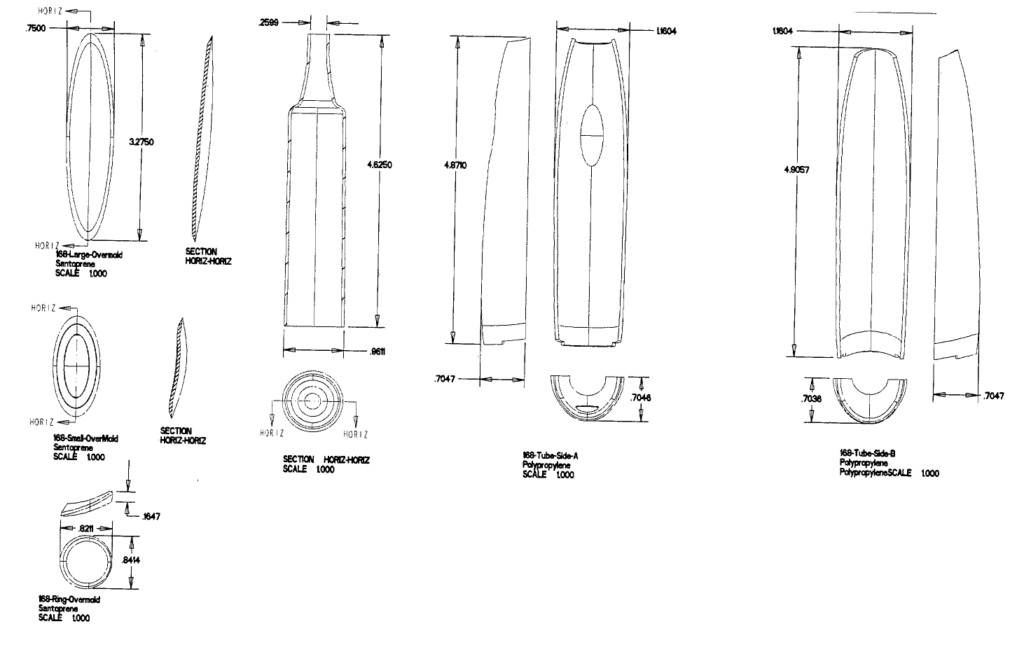

Toothbrush with refillable toothpaste cartridge and changeable bristle head.

Toothpaste is extracted onto the bristle with twist of knob that is positioned at the base of the toothbrush.

The toothbrush has an interior chamber that is designed to be filled directly to the chamber, or to snap in a prefilled cartridge of toothbrush that is refillable or reusable.

The toothbrush incorporates overmolded grip and pad and sections.

The toothbrush has a protective cap that fits over the bristle head with a pin that seals the opening from which the toothpaste is dispensed onto the bristle head. This prevents drying and clogging of the toothpaste.

### CROSS-REFERENCE TO RELATED APPLICATIONS

1) Storage compartment and hollow tube handle also consist of plastic, that reservoir inserts into; suitable materials are polypropylene and polyethylene in opaque translucent or transparent form.

2) A dial with grippable head is joined together with double start thread that is connected to a plunger which serves as a means for forcing toothpaste from reservoir onto the bristles, suitable materials are polyethylene and polypropylene.

3) The head unit has a hollow opening in which toothpaste can flow from reservoir onto bristles. Said head cover snaps onto bristles to prevent drying and clogging of toothpaste.

4) Small and large overmold that connects to tube, position on front and back for better handling and grip, ring overmold positioned between head and tube section allowing for the support of the two units. Suitable materials are santoprene

1. Reusable refillable toothbrush with chamber that dispenses toothpaste.
a. an inner chamber that inserts into bottom of the tube handle, designed to be filled directly to the chamber or to snap in a prefilled cartridge of toothpaste.
b. toothbrush head section having bristles thereon and having one opening therein.
c. tube and reservoir section having a single opening, each towards head and bristles.
d. attachable head section that connects tube and reservoir, such as to allow toothpaste to pass through onto bristles.
e. a rotating dial mounted outside of the tube section and reservoir and under the base section.
f. double start thread connected to plunger, which serves as a means of forcing the toothpaste from reservoir through head section onto the bristles.
g. large and small overmolded grip and pad sections on front and back of the tube.

2. Toothbrush as in claim 1, wherein the dial attaches with base and said plunger section.

3. Toothbrush as in claim 1, with base section overlaps dial section, front and back.

4. Toothbrush as in claim 1, reservoir that inserts into tube section, both having one opening each, to said head.

5. Toothbrush as in claim 1, with small and large overmolding attached to front and back of tube section to allow for better grip and handling.

6. Toothbrush as in claim 1, tube section is ergonomically shaped.
